(19) United States
(12) Patent Application Publication
(10) Pub. No.: US 2002/0184535 A1
(43) Pub. Date: Dec. 5, 2002

(54) Method and system for accessing a resource in a computing system

(76) Inventors: Farah Moaven, San Francisco, CA (US); Israel Laracuente, South San Francisco, CA (US)

Correspondence Address: GLENN PATENT GROUP, 3475 EDISON WAY, SUITE L, MENLO PARK, CA, 94025, US

(21) Appl. No.: 09/870,860

(22) Filed: May 30, 2001

(51) Int. Cl. H04L 9/32

(52) U.S. Cl. 713/202

(57) ABSTRACT

In a method and system for accessing computing resources, such as computing devices and application programs, the approval process is separated from the process of accessing a resource. Consequently, once the approval process for a resource profile is granted by the corresponding resource owners, a user may subsequently access the resource in the resource profile without needing to request again for access approval for the same resource profile. Furthermore, a resource owner may grant access approval to a group of users whose jobs or roles require accessing a common resource, and users who need to access a group of common resources are grouped together, such that the approval process is performed only once for such group of users. A resource owner may restrict grouping of some resources in a resource profile, and assigning a job profile to a resource profile.

### BACKGROUND OF THE INVENTION

1. TECHNICAL FIELD

The invention relates to accessing resources in a network of a computing system. More particularly, the invention relates to a system and a family of methods that provide for separating an approval process for accessing a resource from the process of accessing the resource.

2. DESCRIPTION OF THE PRIOR ART

Presently, whenever a user of a computing enterprise desires to access a computing resource, such as a computing device or application program, the user has first to obtain approval from the resource owner before he or she may access the resource. There is no way to separate the access-approval process from the resource-access process such that once the approval process for accessing a resource is granted by the corresponding resource owner, a new or existing user may subsequently access the resource without needing to request access approval again for the same resource. This results in inefficient and slow access-approval process.

Furthermore, in prior multi-user computing systems, a resource owner grants approval for accessing a resource to a user who has requested the access approval. Such systems do not allow the resource owners to associate their approval for accessing a resource to a job profile or workgroup that require a common resource. Therefore, such systems require each user to request access approval for each resource individually, which results in high traffic and a slow system. There is currently no way of dynamically assigning users who need to access a common group of resources, such that when the approval process is granted for accessing a resource profile, even a new user who is associated with such resource profile may access a resource in the resource profile, without needing to request for access approval.

There is a need, therefore, for separating access-approval process from the process of accessing the resource, which solves the above problems. There is also a need for assigning users to a group of resources in a resource profile, which is pre-approved for access, and allow such users to directly access a resource in the resource profile.

### SUMMARY OF THE INVENTION

One presently preferred embodiment of the invention provides a system and a method for requesting access to a resource, such as a computer device or application program, in an enterprise. The method includes creating a resource profile that includes at least one resource, and creating a job profile related to a group of users. The method further includes assigning the job profile to the resource profile, and requesting at least one resource owner to approve accessing the resource profile assigned to the job profile, such that a user who is assigned to the job profile gains approval to access a resource included in the resource profile.

Another presently preferred embodiment of the invention provides a system and a method for providing access to a resource in an enterprise. The method includes assigning a user to a job profile that relates to the user, assigning the job profile to a resource profile that includes the desired resource, and providing access to the resource.

Yet another presently preferred embodiment of the invention provides a system for accessing computing resources, including at least one user terminal, at least one database including at least one software module, such as an application program, and at least one computing device. The system further includes means for creating a resource profile including at least one computing device and at least one software module, means for creating a job profile related to at least one user, means for assigning the resource profile to the job profile, means for approving access to the resource profile by at least one resource owner, and means for providing access to at least one resource included in the resource profile.

### BRIEF DESCRIPTION OF THE DRAWINGS

FIG. 1 is a schematic representation of a general layout for resource access management according to a preferred embodiment of the invention;

FIGS. 2(a) and 2(b) are schematic representations of resource access-approval process according to a preferred embodiment of the invention;

FIG. 3 is a schematic representation of resource access process according to a preferred embodiment of the invention; and

FIG. 4 is a schematic representation of a job profile being assigned to a resource profile according to a preferred embodiment of the invention

### DETAILED DESCRIPTION OF THE INVENTION

The invention contemplates new and unique system and a family of methods for efficient accessing of computing devices and application programs, which may be implemented in a network of computer systems, such as the Internet.

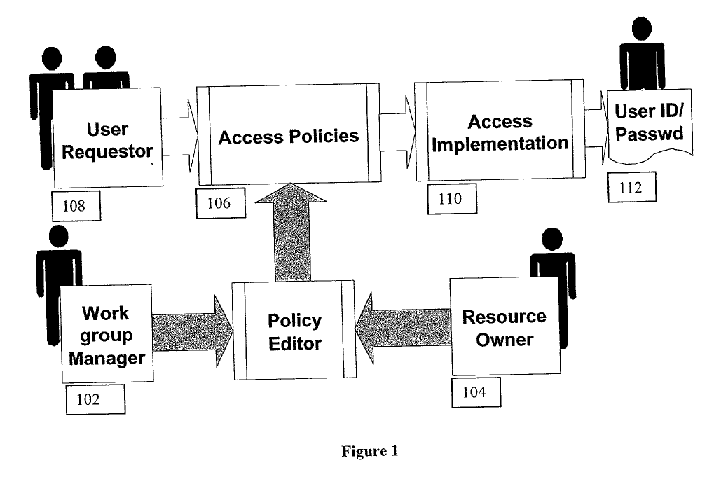

FIG. 1 provides a representation of a general layout of the presently preferred embodiment of the system and method of the invention. To achieve separation of the approval process from the access process for accessing a resource, an authorized person from an organization, such as a workgroup manager 102, may interact with one or more resource owners 104 to negotiate and establish resource access policies 106. The resource access policies 106 may include resource owners' approval for rights and privileges that the workgroup manager may assign to intended users of the system. These rights and privileges include rights and privileges to access one or more resources that are approved for access by their respective resource owner. Preferably, the approval process is performed before a user of the system is assigned to a resource profile to access such resources.

The system of the invention may be implemented as a policy-driven system, which implements the necessary internal security controls and ensures end-to-end audit trails for the system functions. These policies control user authorities and access privileges. The policies may not include users access policies, because the preferable way that a user can get access to a computing resource is through his or her association with a job profile or workgroup. These policies may include:

Explicit Inclusion

Implicit Exclusion

Explicit Exclusion

Explicit inclusion policies include active and approved policies that define authorization and privileges across computing resources. These policies may be for many different types of authorizations, such as building a resource profile, which is a bundling of some computing resources together, and associating a resource profile with a job profile, which determines the accesses required by that job profile. Another example of these policies is ‘grant-access policy.’ Through this policy, resource owners may grant authority to managers who may allow their staff to access the computing resources that are associated with a workgroup or job profile.

Implicit exclusion policies include policies that may not exist in policy files. These policies are the opposite of the explicit inclusion policies, which means that the access authorizations and privileges may be denied for a user until he or she is granted an approved explicit inclusion policy. If an entity is not specified in inclusion policy, that entity is implicitly denied access to a resource.

Explicit Exclusion policies include active and approved policies that explicitly deny access authorization from a user, i.e., specific jobs with a certain access profile may have access to specific computing resources. Resource owners may restrict accessing and/or viewing their resources according to various criteria, such as job codes, time of a day, business unit, day of a week, and other resources to which a user has access.

The policies preferably control the following types of authorizations and privileges:

Organizational hierarchy, which may include association of groups with departments, workgroups with groups, and the like.

Managerial Authority. This association specifies different types of authorization that may be granted to team members. For example, some team members may be responsible for an accounting unit (AU) or cost center (CC).

Team members' organizational relationships, which may include association of team members with a department, a group, a job code, or a workgroup.

User's roles. These policies show associations of the team members with roles and responsibilities, which control functions that users can do within an organization.

Delegation of authority to others, including functions that delegatees can do based on their roles.

Ownership of resources. These policies show association of users with computing resources as the owner of the resource.

Access privileges granted to organizational units through Profiles. These policies show the association of organizational units, job codes, or workgroups with computing resources.

Users' access privileges to the computing resources. These are the actual users' access privileges on the target platforms. These policies may show the association of users with computing resources. These policies may not include direct association of a user with a computing resource; rather they may be the result of creating user's account on the target platforms.

Resource viewing policies, which may include association of users with computing resources for viewing the resources.

To become a registered user, a first-time user needs to sign in and register with the system of the present invention. The user may use a WEB-enabled agent to register with the system of the invention. The data communications between the user and the system of the invention are preferably encrypted, for better security. After a user is registered with the system of the invention, the system may preferably authenticate his or her future accesses to the system.

Users play important roles in the system, and proper and controlled management of their access privileges to the computing resources is one objective of the system. Every user or team member preferably owns two sets of data/attributes in an organization, e.g., in the human resource files:

Personal Information, such as name, social security number, genders, and address.

Assigned Information or attributes that an organization assigns to the users, such as employee number, full-time or part-time status, job code, AU/CC number, work location, and telephone number.

The system may assign other sets of attributes to a user who becomes a registered user. These attributes may specify the person's roles in the organization. In addition to the roles, users may be also associated with job profiles and workgroups, which may be used to capture and determine users access profiles.

A user may become a manager, with specific rights and responsibilities, in two preferred ways:

1. Users may request their managers for becoming a manager. If a manager approve the request, the system of the present invention assigns the users the rights and privileges associated with the manager's role; or

2. An authorized manager may assign the role of a manager to a user.

A manager may have the authority to (1) authorize accessing computing resources under his or her control, (2) build resource profiles for associating resources to users, and (3) negotiate for acquiring access to resources outside his or her control. These functions are explained in more detail below.

Creating Resource Profiles

A manager may create a resource profile, which is a grouping of resources, including computing devices and application programs. A resource profile may be assigned to a job profile. The manager may build different job profiles for different job functions. Jobs that require the same resources may have multiple profiles assigned to them. Profiles may even include other profiles.

A manager may negotiate with one or more resource owners to get approval for accessing the resources within a built resource profile. After the resource owners have authorized their resources within a resource profile, users that are associated with job profiles that are assigned to the resource profile are automatically given all the access rights that are specified in the resource profile. A resource profile preferably includes access rules pertaining to the resources included in the resource profile.

Resource profile is a grouping of resources and applications built by a user with the appropriate managerial authority, defining the systems access policies required to perform a particular job function for a particular workgroup. Resource profiles are access policies that are associated with groups, departments, job codes, or workgroups. Through this association, users' access privileges are set according to their job requirements. Resource profiles may have the same attributes as policies do such as:

Resource profiles have owners; the person who created the profile.

The system maintains a description, which documents the purpose of a resource profile.

Every resource profile has effective and expiration dates (default dates are the creation dates).

Every resource profile maintains specific state and status information. The state information includes ‘request’, ‘approved’, ‘disapproved,’ and ‘hold.’ The status information includes ‘active’ and ‘inactive/cancelled.’

Resource profiles may be established by workgroup managers or by resource owners.

Resource profiles may be inclusion or exclusion policies.

Resources grouped under the same resource profile may have their own expiration dates, which may not be beyond the profile's expiration date.

Resource profiles may also be composed of other resource profiles. Resources may be associated with a resource profile. Through this association, a resource can be associated to one or many profiles. For example, the resource profile “Bank_Teller_Resources” contains the resources needed by the bank tellers of a bank to perform their jobs. This resource profile may specify access policies to computing devices A and B, but may exclude access to computing device C. Resource owners may specify further rules to exclude resources or users. If a manager attempts to build a resource profile that includes a resource excluded by its resource owner, the manager is informed that his or her resource profile is unauthorized.

Creating Job Profiles

A manager may create a job profile, which may include workgroups, jobs, projects, roles, or any other object construct that represents a job function or functions. A job profile may contain other job profiles. The users that are assigned to a job profile inherit the access rights and privileges assigned to the job profile.

Role policies control functions that users are authorized to perform. Preferably, users may not affect their role without obtaining additional approval. For example, to become a resource owner, the user submits a resource owner role request to the proponent of the resource. Upon the approval of the request, the user is granted resource owner role for the specified resource. Alternatively, the proponent may assign resource owner role to a user at his own will. The policy that is created by this assignment authorizes the user to become the resource owner for the specified resource. Role policies may include:

User Role

A user is anyone who has access to the system. The user may view his personal information. He may specify and retrieve his initial and/or temporary password. Users may change their password.

Contractor Role

A contractor is a special case of a general user. A contractor has an expiration date that overrides any later expiration dates for any access given to him.

Security Officer Role

Security officers maintain proponent information, may register new resources into the system, and may identify the resource owners. The proponent's and resource owner's information for the resource may be obtained from the security plan. A security officer preferably has authority to create, modify, view, and list policies. A security officer also may have the ability to grant authority to create, modify, delete, view, and list policies to other users.

Proponent Role

A proponent is the head of a business unit who owns many computing resources. A proponent may authorize the owner of computing resources owned by his business unit. They may delegate this authority to other people in their business unit. The proponent may also certify/verify persons who have been specified as the owners of their resources.

Resource Owner Role

Resource owners, also known as a security liaisons, are responsible for specifying inclusion and exclusion access policies to their respective computing resources. A resource owner may approve grants access policies submitted by the managers. A resource owner should certify/verify jobs, workgroups, people, etc. who have access to his or her resources. A resource owner may certify/verify the exclusion policies. A resource owner may certify/verify his or her resources. This means, if a resource is obsolete, the development group should notify the resource owner. A resource owner may make a resource obsolete/inactive, so no one can get access to the resource. A resource owner also may participate in building access rules for his or her resources.

Workgroup Manager Role

An accounting unit or cost center manager may authorize accesses to computing resources at his disposal. A manager may build a resource profile and assign the profile to a job, workgroup, or project team in his or her area. Managers may negotiate acquiring grant-access policies with a resource owner when they are assigning a resource profile with a job or workgroup in their areas. After a manager receives approval from the resource owner, the manager may assign his or her team members to those jobs/workgroups according to the team members' roles and responsibilities. This process may include obtaining access on the target platforms. A manager may obtain and maintain non-disclosure contracts and other pertinent security forms required by the security standards. A manager may be responsible to certify his or her staff's access to resources, and ensure that their access is according to their job's responsibilities. A manager may not approve access to any resource for himself or herself. For a manager to obtain access to a system, his or her manager may assign the manager to a job and/or workgroup. A manager may delegate the authority for granting access to his or her assistance.

Account Administrator Role

Account administrators may perform account administration tasks. Account administrators may monitor/review who has access to their specific platforms/applications. They may monitor accounting key events, such as when an account is not created due to system/platform unavailability or when an account is created outside of the system. They may review lists of managers who have not certified their users access profiles according to the system's policies. They may also participate in defining access rules for their platforms/applications.

Resource Owner Delegation Role

Resource owners may delegate only creating inclusion policies. They may not delegate this task to anyone else.

Requestor Role

A requester is a user to whom a manager has delegated access request authority/function. This user may register a new user and assign him to an existing job code. A requestor may not request access to any resource for himself. A requester may not delegate his responsibilities to someone else.

Delegation of Authority/Role

A manager or resource owner may preferably delegate authority over a resource or workgroup to another user. Delegation of authorities is managed via specific policies that the system maintains for each role and responsibility. A manager or a resource owner, who has been identified as the primary person for the role, may create a delegation of authority policy in order to delegate specific functions. There may be a higher-level policy that controls functions that a manager or resource owner may delegate. However, there are specific functions that a manager or a resource owner may not delegate. The system may notify managers or resource owners of actions performed on their behalf if a rule exists in the delegation policy to do so.

Workgroups are the representation of the structure(s) of an organization. They may have one direct workgroup above and many below them. This structure may be implemented by having a collection of organizational policies, where each of which locates the workgroup within a particular dimension. A workgroup may have many team members, but only one manager. The association of the workgroups with each other specifies the structure of the organization. Workgroup definition, managers, and authorizers need to be easily manageable/maintainable.

Separating Access Implementation Process from the Approval Process.

According to the preferred implementation of the invention, the approval process occurs before the system grants an actual access. For the workgroup manager to request access to resources, a manager may obtain approval from one or more resource owners at the time he is building or modifying an existing resource profile. The workgroup managers may justify to resource owners the business needs for which their workgroup needs to obtain access to the resources. This separation process ensures that system owners approve all accesses to their systems according to business needs. In addition, it also removes the time lags resulting from the resource owner needing to approve or deny a request before the access is granted.

For example, a manager may define a job profile that specifies the access rights and privileges required by a workgroup, such as “Job_Function_Bank_Teller” for a workgroup of bank tellers. The members of a bank that perform the roles or functions of a bank teller may then be assigned to the workgroup “Job_Function_Bank_Teller.”

Assigning a Resource Profile to a Job Profile

Once a resource profile and a job profile are created, or using existing profiles, they may be assigned to each other by a manager. A resource profile is preferably assigned to a job profile only once. The assignment may generate a policy that may include a unique identifier, description, date of creation, effective and expiration dates, status, and an owner. The assignment may generate and send one or more resource access requests to at least one or more resource owners of the resources included in the resource profile. The resource owners may approve or deny accessing their respective resources for the specified job profile. If the resource owners approve accessing their respective resources, which are included in the resource profile, the manager may assign users to the specified job profile. Consequently, the users that are assigned to the specified job profile gain access rights and privileges to the resources included in the resource profile that is assigned to the specified job profile.

Resource profiles may be associated with any of the elements of an organization, such as a division, a department, a group, a job code, or a workgroup. Through this association, all resources specified in that profile may be accessible by the users who are associated with those groups, departments, or job codes. After a manager creates these associations, he or she may request grant access authority from the resource owners. Through this authority, the resource owners are allowing the manager to assign this resource profile to his or her staff that is responsible for the specified job.

For example, when the assignment and approval of a resource profile, e.g. “Bank_Teller_Resources,” to the job profile “Job_Function_Bank_Teller” is approved, the members of a bank that perform the role and jobs of a bank teller may access the resources included in the resource profile “Bank_Teller_Resources.”. Advantageously, new bank tellers who may later join the bank are also able to access such resources after their managers have assigned them to the “Job_Function_Bank_Teller” job profile, without needing to go through the approval process every time they desire to access such resources.

Assigning a Team Member to a Jos Profile

When a user is associated with a job profile, such as a job, project, role workgroup, or some other organizational object construct the user may be granted the access rights that the resource profile assigned to that job profile provides. A manager may associate his team members with relevant organizational job profiles. If an attempt is made to assign a user to two workgroups that have resources that cannot be accessed by the same user, the manager may be notified of the resource conflict so that he reassigns the user to the appropriate workgroup. The association of a team member to a job profile produces a policy that includes information about the team member's identifier, the job profile identifier, creation date, effective and expiration dates, status, and the creator.

In the bank-teller example, as new bank tellers join the organization, a bank manager may associate them with their appropriate job profile, “Job_Function_Bank_Teller.” Because the resource access permissions for performing this job function have been approved previously by the respective resource owners, during the approval process, no further approvals or authorizations for accessing such resources are required. The system of the invention automatically creates the necessary accounts with the appropriate accesses for such resources, when requested by the users. This process may be done through intelligent agents on the target systems in a speedy and efficient way, provided the target resources are available.

Terminations and Transfers of Users

When a team member is terminated or transferred out of an organization, his manager may attach either a termination date or an expiration date to the resource profiles and/or policies associated with that user. If a user is terminated, the system automatically terminates that user's association with the job profiles of the organization, and all accounts for all resources established for the user are disabled on the termination date. The system may provide the manager with a facility through which the manager may specify to whom the user's policies and/or files should be transferred. According to the manager's instruction, the system may delete the user's files, but not access policies if the access policies are used in other policies.

When team members transfer to a new group, their managers may assign them to a job profile associated with the new group. Upon the users' registration, the system may automatically suspend the users' access to the resource profiles they no longer need, maintain their access to the resource profiles that they still need, and create access privileges to new resource profiles that they need in their new group. If a team member is transferring to a new business group, the system may notify the team member and his new manager that he is about to loose his access privileges. The new manager may register the team member to his new role and insure that the team member receives new privileges associated with his new job function.

Viewing a Resource Profile

While building a resource profile, if managers cannot find specific resources on the list of resources that they may view and include in a resource profile, they may send requests to the resource owners for releasing list of available resources. Upon receiving approval from the resource owners, the manager may view the resource and also may select the resource for building a resource profile.

Delegating Managerail Responsibilities

Managers may delegate all or some of their job responsibilities to other team members in their workgroup. The managers may specify an expiration date for the delegated responsibilities, and may delegate the following tasks:

1. Creating a profile and naming it.

2. Browsing an authorized list of resources and selecting the resources to be assigned to either a new or to an existing resource profile.

3. Changing a selected group of resources in a resource profile.

4. Setting expiration dates for one or all resources that are bundled in one resource profile.

5. Setting expiration dates for profiles.

6. Registering a new group/workgroup/project team.

7. Assigning a resource profile to a job profile.

8. Justifying the reason why a job profile needs the requested resource access.

9. Assigning team members within the manager's organizational unit to a job profile or workgroup.

10. Assigning termination dates to a terminated team member's profiles.

11. Assigning expiration dates to a transferring team member's profiles.

12. Registering new team members with the system.

Certifying Access Privileges

A manager may certify or verify the resource profile that he has properly associated with workgroups or jobs within his group. This certification may indicate that workgroups or jobs still need to have the access to the resource that has been assigned to them. This task may be performed regularly e.g. once every quarter, and it may not be delegated. Managers may also certify and or verify that his team members still are performing the jobs and or tasks for which they have obtained access to resource profile. This task may also be performed regularly e.g. once every quarter, and it may not be delegated. Managers may also certify that the team members listed in their workgroups still work for them in the assigned capacities. This task may be performed regularly, e.g. once every quarter, and it may not be delegated. For the above certifications, the system may create audit trails.

Reviewing Listings

A manager may obtain many listings from the system, such as:

To what resources a user has access.

To what job profiles a user is assigned.

To what job profiles workgroup's team members are associated.

List of users who are associated to a job profile and the resources to which they have access.

List of workgroups.

List of workgroups and their associated team members.

List of workgroups and their associated resource profiles.

List of workgroups associated with other specific workgroup.

List of resources at the manager's disposal with which he or she may build profiles.

List of profiles that the manager has defined.

List of profiles associated with a job code/workgroup.

List of users assigned to job profiles via their association with job codes/workgroups.

List of profiles with their owners' identifications.

Profiles close to their expiration date.

Profiles created in the past period of time.

List of profiles and their associations with other profiles and applications.

Functions

Functions Performed by a Resource Owner

Requesting to Become an Authorized Resource Owner

A user, after properly registering with the system of the invention, may request a resource proponent to approve his or her role as a resource owner. Alternatively, the resource proponent may grant authorization to a team member to become a resource owner. A resource owner may perform specific privileged functions, which may be required for internal security of the system. These functions may not be delegated.

Registering New Resources

Resource owners may register new computing resources. Resources may have effective and expiration dates, which may specify the dates that a new resource becomes operational, i.e. is available for access, or becomes obsolete and or decommissioned, i.e. no more access are allowed. Resource owners may register each component of their systems individually or as applications group, and may activate or inactivate the components, such as files, programs, etc., of an application automatically and in a global mode, if it is desired. Once a resource owner inactivates an application, or a component of an application, the existing policies for that resource may become inactive as well.

Approve ‘Grant Access’ Policies

Resource owners may approve or disapprove grant access policies requested by the managers. The grant access policies may authorize the managers to grant access to resources assigned to a specific job in their group. If a resource owner does not approve a manager's request for assigning the resource profile to a job within the specified time line, it should be reported to the manager, e.g. via e-mail.

Multiple Resource Owners Approve a ‘Grant Access’ Policy

Some requests may require approval from many resource owners, such as application owners and compliant officers. The system may have a facility that may collect these group approvals. The system may also have a facility that may collect these group approvals in a specified order.

View Access Privileges/Policies to Computing Resources

Resource owners may view the following listing:

Users who have access to the computing resources.

Workgroup managers who have grant-access authorities to computing resources.

Job codes and workgroups that are associated with their resources.

Workgroup managers who have grant-access policies to their resources and the job code or workgroup for which the policy has been established.

Job profiles that are associated with their resources.

Workgroup managers who have view resource policy.

Maintain Resources

Resource owners may add resource, remove resource, or modify access to a resource, e.g. time restrictions. The system may have automated facilities, such as intelligent agents, that may download data for applications, components, and/or platforms to resource files.

Search Computing Resources

The system may provide authorized users with means to search a database for a resource or application that meets specified criteria. Keywords, text descriptions, dates, etc. may be used as search criteria.

Request Resource View Policy

A workgroup manager should be able to send requests to resource owners to gain permission to view a resource, application, or resource group.

Create ‘Resource View’ policies

Resource owners may have a facility that they may grant view policies to workgroup managers. Without these policies, workgroup managers may be able to see the resource and select one for their resource profiles. These policies may secure resources from being viewed by all workgroup managers. Resource owners may be able to approve view policies submitted by a workgroup manager.

A resource owner, using agents and development teams responsible for the technical support of the resource owner's systems, should register new resources to be used in the system of the invention. A resource may include a file, a device, a software module, or any other element of computer system's hardware or software that provides computing services.

Approving Requests for Getting Access to Resources

As discussed above, when a manager assigns a resource profile to a job profile, this action may create an access request directed to the corresponding resource owner. The resource owner may review the request and, preferably according to the manager's business justification, may approve, disapprove, or hold the request. Once the resource owner approves the request, the resource owner grants authorization to the manager that he or she may grant access right to his or her team members to access the resource. This approval process is preferably performed only once for each resource profile. After this approval process is complete, the resource owner may not receive approval requests for the same resource profile from the manager. Managers may associate that resource profile to a job profile that may also include new team members.

Approving Requests to View Resources

When a manager cannot view a resource, such as an application, system, or platform, and he must learn more about the resource to build a resource profile, he or she may request the resource owner to view the resource. The resource owner may approve, disapprove, or hold the request. Upon approval of the request, the manager may view the resource.

Creating Resource Profiles

Resource owners may create resource profiles and name them. They may specify an expiration date for the resource profile. This task may be performed as many times as the resource owner wishes to create new resource profiles. A resource owner may browse through his or her list of resources, such as servers, applications, transactions, and devices, and select the resources that he or she wants to assign to a new profile. He or she may assign the selected resources to the resource profile. A resource owner may create exclusion policies for some resources, indicating the resources that should not be bundled together in one profile. These resources may be the resource owner's own resources or they may belong to other resource owners.

Assigning a Resource Profile to a Job Profile

After creating a resource profile, or using an existing resource profile, a resource owner may assign the resource profile to a job profile, such as a job, a workgroup, or a project team. This task accomplishes at least two objectives:

Specify jobs, projects, and workgroups that are authorized to use the resource owner's resources.

Specify jobs, projects, and workgroups that are not authorized to use the resource owner's resources. This may happen when the resource owner creates an exclusion policy. The exclusion policy may indicate that there are specific jobs and workgroups that may not be authorized to access certain resources. Specifying an exclusion policy may not be delegated.

Retiring Resources

A resource owner may retire a resource, such as system, an application, or a platform, that is no longer in use. A resource owner may flag the retired resources as inactive. When a resource is flagged as retired, the system may disable accesses to that resource and may not create any new accounts for a user attempting to access that resource.

Maintaining Resource Profiles

A resource owner may process changes to his or her existing resources and profiles. The resource owner may change the resource profile mix by adding and removing resources from the resource profile. Upon removing resources from a resource profile, the job profiles that are associated with the resource profile containing the removed resources may loose their access to the removed resources. Upon adding resources to a resource profile, the job profiles that are associated with the resource profile containing the added resources may gain access to the added resources. Adding to or removing resources from a resource profile may affect some or all job profiles that are associated with the resource profile, at the option of the resource owners.

Delagating Responsibilities

Resource owners may delegate some or all of their roles and responsibilities to other team members in their workgroup. Resource owners may specify an expiration date for a delegated responsibility. A resource owner may delegate the following tasks:

1. Creating resource profiles and naming them.

2. Browsing an authorized list of resources, such as servers, business applications, transactions, and devices, and selecting the resources to be assigned to either a new or to an existing resource profile record.

3. Changing selected resources in a resource profile record.

4. Setting expiration dates for profile records.

5. Registering a new group, workgroup, or project team.

6. Assigning a resource profile to a job profile.

7. Justifying the reasons why a job profile needs the requested resource access.

Certifying Access Privileges

Resource owners may certify or verify the resources that they have associated with resource profiles. This certification indicates that job profiles that have access to the resources within these resource profiles still need to maintain their access rights. This task may be performed periodically, and it may not be delegated. For the above certification, the system may create audit trails.

Reviewing Listings

A resource owner may obtain many listings, such as:

List of his resources, including active and inactive resources.

List of users who have access to his or her resources.

List of profiles that contain his or her resources.

List of job profiles or workgroups that are associated with his or her resources.

List of workgroups and their associated team members who have access approval to his or her resources.

List of profiles that he has defined.

List of profiles with their owners' identifications.

Profiles close to their expiration dates.

Profiles created in a past period of time.

List of profiles and their associations with other profiles and applications.

Profile policies preferably include a unique identifier, a name, effective and expiration dates, state, and an owner. The system is flexible and configurable such that adding and removing groups, divisions, department, and workgroups are performed easily. Such changes, which may be necessary to update team members' access privileges due to organizational changes and are, preferably, carried out with least effort and interaction with the system. Workgroups also preferably include an identifier, a description, effective and expiration dates, a state, and an owner.

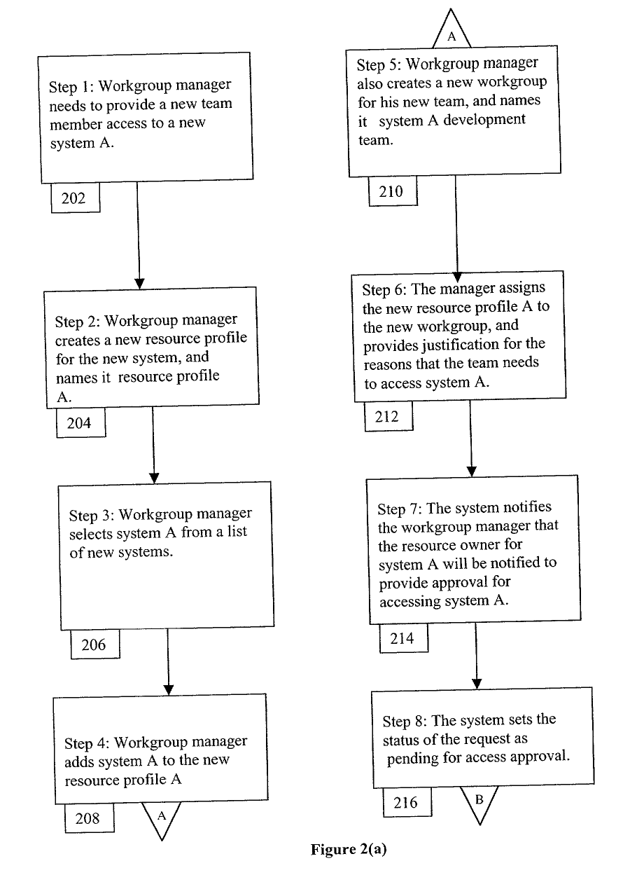

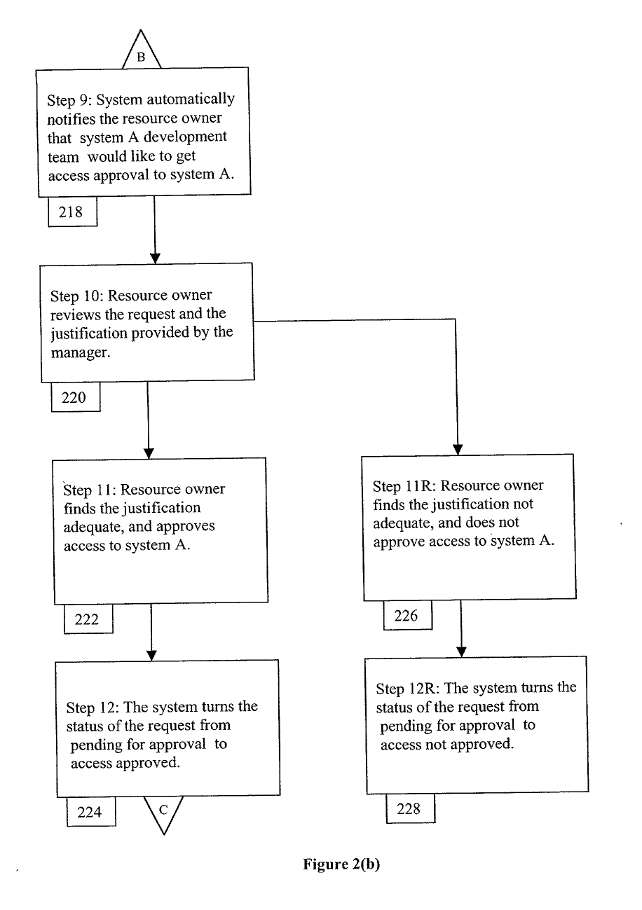

FIG. 2(a) shows a representation of a scenario when a workgroup manager in an organization desires to provide access to resources to team members within his or her workgroup, 202. The manager may create a new resource profile, including computing resources that may be needed for a project to be done by the team members, 204. The manager may preferably select the desired resources from a list of resources provided by resource owners, 206 and 208. The manager may also create a workgroup, including the team members who need to use the resources, 210, based on their jobs, roles, or functions. The manager may then assign the workgroup to the resource profile, and may provide justification for needing to access the resources in the resource file, 212. After receiving access approval from the resource owners, existing or new team members that are specified within the workgroup may access the resources included within the resource profile. The system preferably may notify the manager that the resource owners for the resources in the resource profile are requested for granting access to their resources, 214. The system may then set the status of the request to a pending-for-approval status, when the approval process is processed.

FIG. 2(b) shows a representation of a scenario when resource owners are requested to grant approval for accessing their resources, 218. Such requests preferably originate after the manager assigns a workgroup to a resource profile. Upon the resource owners reviewing the request for approval and the justifications provided therefore, 220, the resource owners may find the justifications adequate and thus provide approval for accessing the resources, 222. In this case, the system changes the status of the request from pending to approved, and notifies the manager of the access approval, 224. On the other hand, if the resource owners find the justification for accessing their resources inadequate, 226, the system may change the status of the request from pending to not approved, and notify the manager of the access disapproval, 228.

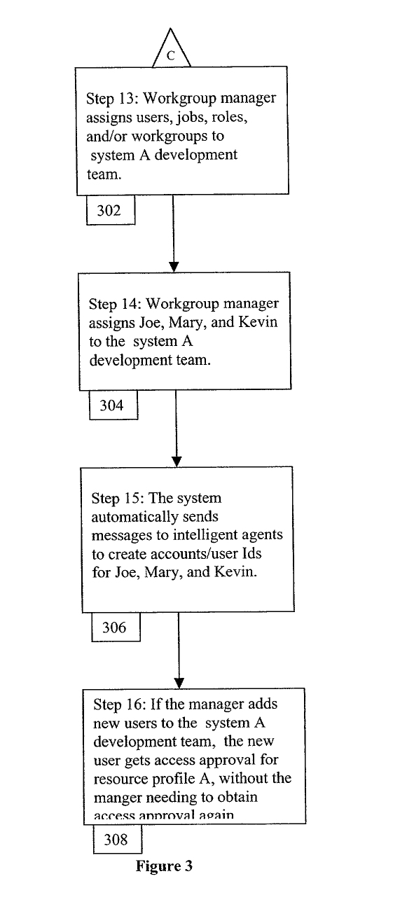

FIG. 3 shows a representation of a scenario when a workgroup manager in an organization assigns his or her team members to a workgroup that has been previously assigned to an approved resource profile, as explained above in connection with FIGS. 1(a) and 1(b), 302. For example, the manager may assign three of his team members, Joe, Mary, and Kevin, to such a workgroup, 304. After the team members are assigned or added to the workgroup, the system may create user accounts and user identifications for the team members 110, 112 (FIG. 1), 306 (FIG. 3. Preferably, the system automatically creates such data, via intelligent agents. Advantageously, the team members may access the resources in the resource profile any time they desire, without needing to wait for access approval by the resource owners. Furthermore, when new team members are assigned or added to the workgroup, the system provides access rights and account information for such team members, who may also access the resources without needing to wait for access approval. This process is preferably performed without a manager's further involvement, 308.

The access approval process may generally include the following scenarios:

1. Getting approval for a new job profile or workgroup to access a new resource profile;

2. Getting approval for a new job profile or workgroup to access an existing resource profile;

3. Getting approval for an existing job profile or workgroup to access a new resource profile; and

4. Getting approval for an existing job profile or workgroup to access an existing resource profile.

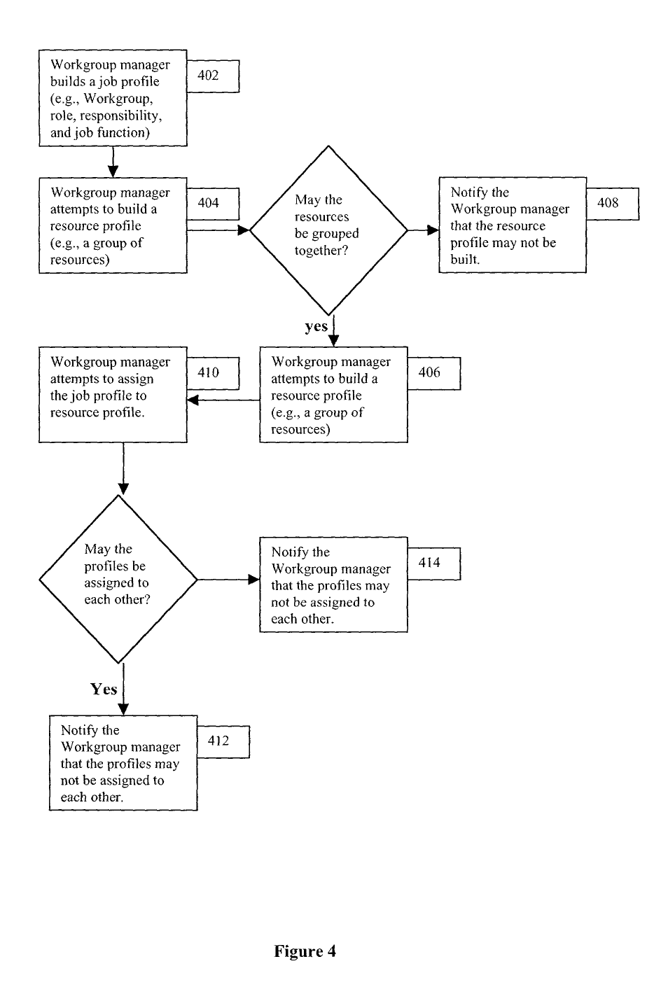

FIG. 4 shows a representation of a scenario when a workgroup manager in an organization assigns a job profile to a resource profile. As mentioned above, a job profile may include workgroups, jobs, projects, roles, responsibilities, or any other object construct that represents a job function or functions. A job profile may contain other job profiles. The users that are assigned to a job profile inherit the access rights and privileges assigned to the job profile. In step 402, the workgroup manager builds a job profile. In step 404, the workgroup manager attempts to build a resource profile. If the resources are not excluded from being grouped together in the same resource profile, the resource profile is successfully built, in step 406. If, however, some explicit exclusion rules dictate that the intended resources are not allowed to be grouped together, in step 408, the workgroup manager is notified that the intended resource profile may not be built.

After the workgroup manager has successfully built a resource profile that passes the exclusion rules, the workgroup manger may attempt to assign the job profile to the resource profile, in step 410. If this assignment does not violate a related exclusion rule, in step 412, the job profile is successfully assigned to the target resource profile. If, however, some explicit exclusion rules dictate that the job profile may not be assigned to the resource profile, the workgroup manger is notified accordingly, in step 414.

The method and system of the invention is preferably implemented as a policy-driven, role-based, or profile-based system, which may manage and control team members' access privileges to many platforms and systems across an organization. The method and system of the invention preferably provides access to a resource via providing access approval for job profiles. This aspect of the invention addresses the security problem of employees having accesses that they no longer need to perform their job functions. The managers, after determining what system accesses their team members need, may build job profiles, accordingly.

Separating the approval process from the access process for accessing a resource removes the time lags resulting from the resource owner needing to review and approve or deny access permission every time an actual access is granted. The approval process may occur before an actual access request is fulfilled.

The method and system of the invention automates the creation of user accounts on target platforms and applications. Preferably, intelligent agents may be used to create or maintain user accounts on target platforms according to instructions received from the managers and the platform's specific access rules and policies.

Thus, the system and method of the present invention save time in accessing a resource in computing systems. By separating approval process for accessing a resource from the actual process of accessing the resource, and having a profile of resources already approved for access process, a fast and secure resource accessing system is achieved. When a user of such system initiates a request for accessing a resource included in the resource profile, the user is assigned to a job profile that is associated with a resource profile and gains access rights and privileges already approved for the resources in the resource profile.

Accordingly, although the invention has been described in detail with reference to particular preferred embodiments, persons possessing ordinary skill in the art to which this invention pertains will appreciate that various modifications and enhancements may be made without departing from the spirit and scope of the claims that follow.

1. A method for requesting approval for accessing a resource in a system of resources, comprising the steps of:
creating a resource profile including at least one resource;
creating a job profile that is related to at least one user;
assigning said job profile to said resource profile; and
requesting a resource owner of said resource profile to approve access to said resource profile assigned to said job profile, such that a user assigned to said job profile gains approval for accessing said at least one resource included in said resource profile.

2. The method of claim 1, wherein said requesting step automatically originates from said assigning step.

3. The method of claim 1, wherein said resource profile includes at least one computing device.

4. The method of claim 3, wherein said resource profile includes at least one software module.

5. The method of claim 1, wherein said job profile includes at least one job.

6. The method of claim 1, wherein said job profile includes at least one role.

7. The method of claim 1, wherein said job profile includes at least one project.

8. The method of claim 1, wherein said job profile includes at least one workgroup.

9. The method of claim 1, wherein said job profile includes at least one responsibility.

10. A method for providing a user access to a resource in a system, comprising the steps of:
assigning said user to a job profile that relates to said user; and
assigning said job profile to a resource profile that includes said resource, such that said user gains approval for accessing said resource included in said resource profile.

11. The method of claim 10, wherein said resource profile has been previously approved for access by a resource owner of said resource.

12. The method of claim 10, further including granting an account to said user for accessing said resource.

13. The method of claim 12, wherein said account is automatically provided following said assigning said user to said job profile.

14. The method of claim 10, wherein said resource profile includes at least one computing device.

15. The method of claim 10, wherein said resource profile includes at least one application software.

16. The method of claim 10, wherein said job profile includes at least one job.

17. The method of claim 10, wherein said job profile includes at least one role.

18. The method of claim 10, wherein said job profile includes at least one project.

19. The method of claim 10, wherein said job profile includes at least one workgroup.

20. A method of approving access to a resource profile in a system, comprising the steps of:
receiving a request for accessing said resource profile;
evaluating said request by a resource owner of said resource profile; and
deciding to grant access approval such that if access approval is granted, future accesses of said resource profile do not need approval by said resource owner.

21. The method of claim 20, wherein said deciding step includes restricting said resource profile to be accessed by a certain job profile.

22. A system for accessing computing resources, comprising:
at least one user terminal;
at least one database including at least one application software;
at least one computing device;
means for creating a resource profile including said at least one database and said at least one application software;
means for creating a job profile related to at least one user;
means for assigning said resource profile to said job profile;
means for approving access to said resource profile by at least one resource owner; and
means for providing access to at least one resource included in said resource profile.

23. The computer system of claim 22, further implemented on a network environment.

24. The computer system of claim 23, wherein said network environment further comprising Internet.

25. The method of claim 4, wherein at least one of said resource profile, said computing device, and said software modules owned by various resource owners.

26. A method for building a resource profile, comprising the steps of:
determining whether a plurality of resources may be grouped together in a resource profile; and
grouping said plurality of resources in said resource profile if such grouping is allowed, such that if access approval is granted for said resource profile, future accesses of said resource profile do not need access approval.

27. The method of claim 26, wherein said determining step further includes checking against an exclusion rule.

28. The method of claim 27, further including:
Indicating that said resource profile may not be built if said grouping is not allowed under said exclusion rule.

29. A method for assigning a job profile to a resource profile, comprising the steps of:
determining whether a job profile may be assigned to a resource profile; and
assigning said job profile to said resource profile if such assignment is allowed, such that a user assigned to said job profile gains approval for accessing said resource profile.

30. The method of claim 26, wherein said determining step further includes checking against an exclusion rule.

31. The method of claim 27, further including:
Indicating that said job profile may not be assigned to said resource profile if said assignment is not allowed under said exclusion rule.

32. A computer readable medium embodying a method for requesting approval for accessing a resource in a system of resources, said method comprising the steps of:
creating a resource profile including at least one resource;
creating a job profile that is related to at least one user;
assigning said job profile to said resource profile; and
requesting a resource owner of said resource profile to approve access to said resource profile assigned to said job profile, such that a user assigned to said job profile gains approval for accessing said at least one resource included in said resource profile.
